(19) United States
(12) Patent Application Publication
(10) Pub. No.: US 2024/0364166 A1
(43) Pub. Date: Oct. 31, 2024

(54) Solid Motor Coils And Motors Using Same

(71) Applicant: Joby Aero, Inc., Santa Cruz, CA (US)

(72) Inventors: JoeBen Bevirt, Santa Cruz, CA (US); Martin van der Geest, Santa Cruz, CA (US); Sean Friedrich Walter McCluskey, Marina, CA (US); Brandon Beberwyck, San Francisco, CA (US)

(21) Appl. No.: 18/141,461

(22) Filed: Apr. 30, 2023

Related U.S. Application Data
(60) Provisional application No. 63/350,346, filed on Jun. 8, 2022.

(51) Int. Cl. H02K 3/26; H02K 3/28; H02K 15/04

(52) U.S. Cl. CPC H02K 3/26; H02K 3/28; H02K 15/0407; H02K 3/02

(57) ABSTRACT

A solid motor coil with conductive pathways as part of a unitary construction. The conductive pathways are separated by resistive insulating layers. The conductive pathways may vary in their location within the cross-section of the motor coil, which may significantly reduce eddy current losses. The solid motor coil may result in a higher packing factor than previous designs. The solid motor coil may reduce the eddy current loss per conductor, with commensurate reduction in peak temperature rise. An electric motor with solid motor coils provides improved heat conduction and improved efficiency, allowing for a smaller motor package at higher power levels.

### CROSS-REFERENCE TO RELATED APPLICATIONS

This application claims priority to U.S. Provisional Patent Application No. 63/350,346 to Bevirt et al., filed Jun. 8, 2022, which is hereby incorporated by reference in its entirety.

### FIELD OF THE INVENTION

This invention relates to solid motor windings and the printing of such windings, as may be used in an electric aircraft.

### BACKGROUND

The stator of an induction motor consists of a stator core and stator slots. There are different types of slots: open slots, semi-closed slots, and tapered slots. Typically, round wires are wound into coils and reside within the stator slots and around teeth which form the slots. Also, conductor bars of substantially rectangular cross-section may be used. The stator may be an internal stator or an external stator, relative to the rotor.

The current density within a coil is an important aspect of motor design. With increased current density, there may be a reduction in cross-section (and overall size of the motor), and a reduction in weight. However, increased current density can lead to increases in temperature rise, increases in resistance, and a reduction in efficiency.

An example of an end use of a motor may be in an electric vertical take-off and landing aircraft. The amount of thrust required to take-off in a vertical take-off scenario greatly exceeds the thrust needed to keep the same vehicle aloft during forward flight, when the wings are providing lift. The amount of thrust required to transition from a vertical take-off mode to horizontal, forward, flight mode may also be quite high. For electric vertical take-off and landing aircraft, motor efficiency may play a key role in system design.

What is needed is a motor design which is of high efficiency and allows for compact design. What is also needed is a motor coil which can reduce eddy current losses, and which is efficiently able to eject heat from the coil.

### SUMMARY

A solid motor coil with conductive pathways as part of a unitary construction. The conductive pathways are separated by resistive insulating layers. The conductive pathways may vary in their location within the cross-section of the motor coil, which may significantly reduce eddy current losses. The solid motor coil may result in a higher packing factor than previous designs. The solid motor coil may reduce the eddy current loss per conductor, with commensurate reduction in peak temperature rise. An electric motor with solid motor coils provides improved heat conduction and improved efficiency, allowing for a smaller motor package at higher power levels.

### BRIEF DESCRIPTION OF THE DRAWINGS

FIG. 1 illustrates a stator winding.

FIG. 2 illustrates a close-up view of motor coils including a coupled double coil.

FIG. 3 illustrates a cross-sectional view of motor coils including a coupled double coil.

FIG. 4 illustrates a cross-sectional view of motor coils showing the fill factor of a bar coil.

FIG. 5 illustrates a cross-sectional view of a plurality of conductor path portions in a solid motor coil according to some embodiments of the present invention according to some embodiments of the present invention.

FIG. 6A illustrates a cross-sectional view of a solid motor coil and tooth according to some embodiments of the present invention.

FIG. 6B illustrates a perspective view of a solid motor coil according to some embodiments of the present invention.

FIG. 7A illustrates a cross-sectional view of a pair of solid motor coils and teeth according to some embodiments of the present invention.

FIG. 7B illustrates a cross-sectional view of a pair of linked solid motor coils and their respective teeth according to some embodiments of the present invention.

FIG. 8 illustrates a varying path of portions of the conductive pathway in a solid motor coil according to some embodiments of the present invention.

FIG. 9 illustrates an evtol aircraft in a forward flight configuration.

FIG. 10 illustrates an evtol aircraft in a hover configuration.

FIG. 11 illustrates an electric motor as may be used in an evtol aircraft.

FIG. 12 illustrates a cross-sectional view of an electric motor as may be used in an evtol aircraft.

### DETAILED DESCRIPTION

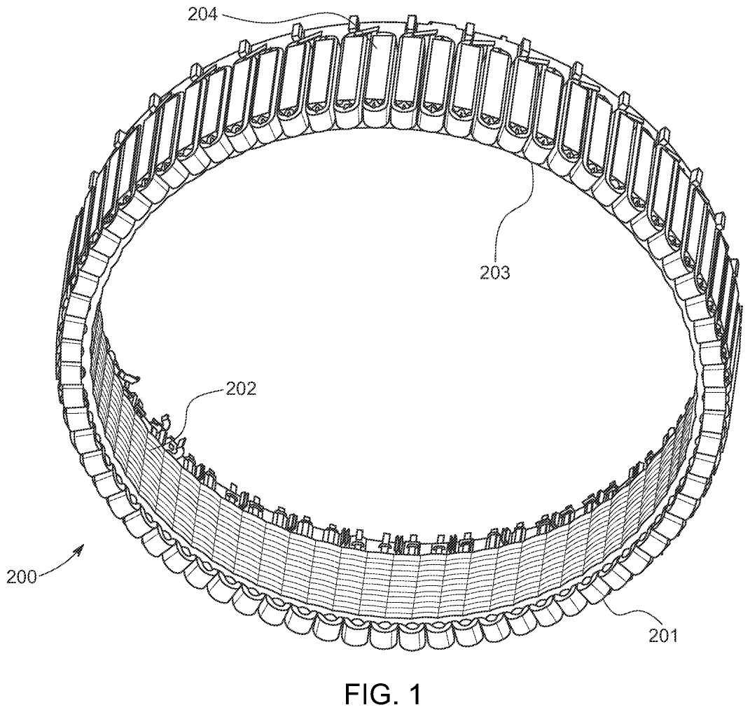

FIG. 1 illustrates a stator 200 which includes a winding 201. The exemplary, illustrative, winding 201 has 72 teeth 204 coupled to a stator support structure 202. A coil 203 surrounds each of the teeth 204, with a portion of each of two coils residing in the slot between two teeth. In this illustrative example, the stator 200 is an internal stator for an outrunner electric motor.

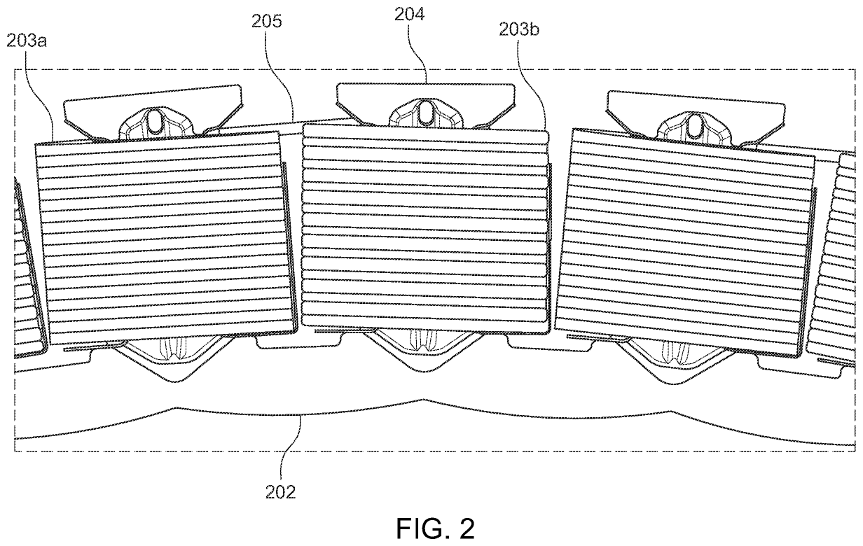

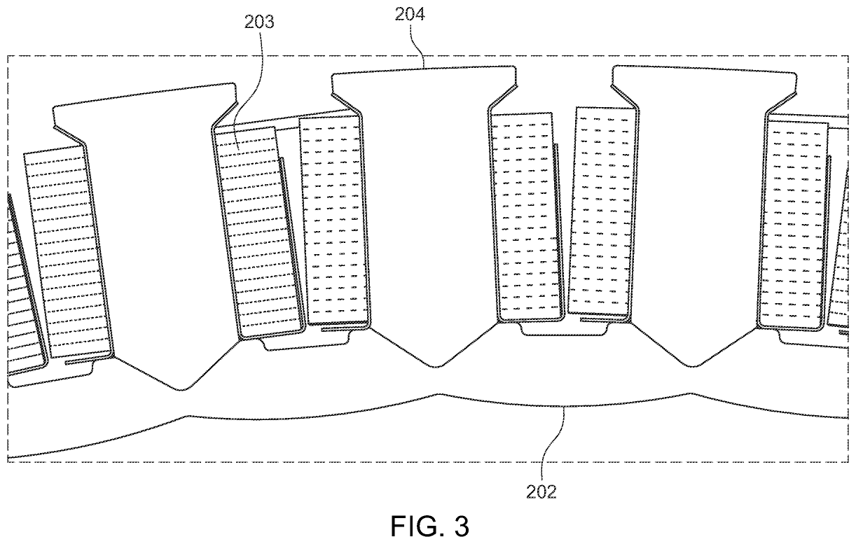

FIGS. 2 and 3 illustrate an end-view and a cross-sectional end view, respectively, of coils 203 in place around teeth 204. A first portion 203a of the coil 203 may reside on a first side of a tooth 204, and a second portion 203b may reside on a second side of the tooth. As the coil is continuous around the tooth, the coil wraps around a first, second, third, and fourth side of the tooth. In this illustrative embodiment, two adjacent coils are coupled together 205 to form a double coil configuration. The coils are of rectangular conductors wound to fit around the tooth 204. In some aspects, the tooth is adapted to be placed through an already formed coil, and then inserted into a mating feature in the stator support structure 202.

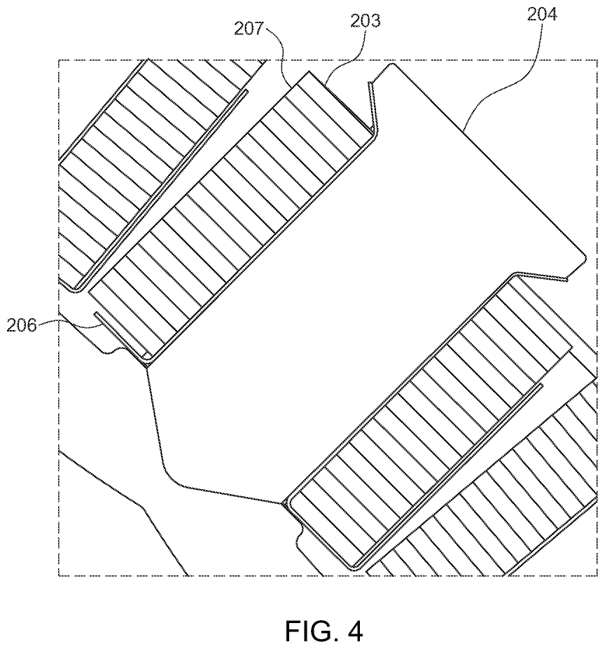

FIG. 4 illustrates a close-up cross-sectional view of a coil and tooth. The coil 203 is made up of turns 207 with rectangular cross-section. An insulator 206 resides between the inner surface of the coil and the tooth. The insulator may also wrap around to insulate adjacent coil outer surfaces from each other.

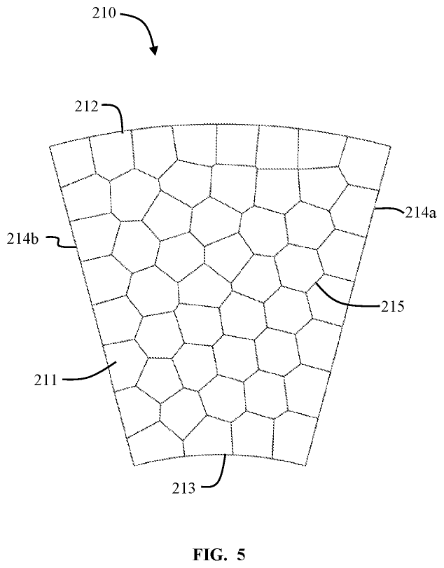

FIG. 5 illustrates a cross-sectional view of a portion of a solid motor coil 210 according to some embodiments of the present invention. In this illustrative embodiment the coil consists of a continuous conductive pathway 211 which routes through a solid unitary piece. As the conductive pathway routes through the solid coil, its outer profile may change, as well as its horizontal and vertical location in the solid coil. This configuration allows the continuous conductive pathway to route longitudinally along a first long section of the coil, then bend around and return along a second long section of the coil, and again bend around to the first long section of the coil. With proper geometric configuration along this routing, the continuous conductive pathway creates a motor coil in a solid construct. The solid motor coil, which is a unitary monolithic piece, routes a conductive pathway along a first, second, third, and fourth direction. Although discussed herein as a single conductive pathway formed into a coiled conductive pathway, in some aspects the solid motor coil could be comprised of more than a single conductive pathway.

The cross-section as seen in FIG. 5 represents a slice through one of the long sections of the coil 210, which will reside along a tooth in the slot between teeth. In between the multiple areas of the conductive pathway are resistive layers 215. As can be seen, there may be a curved exterior surface 212 and a curved interior surface 213. The side surfaces 214a, 214b may ran out radially. Thus, the fill factor with such a coil may be significantly higher than with previous coil types.

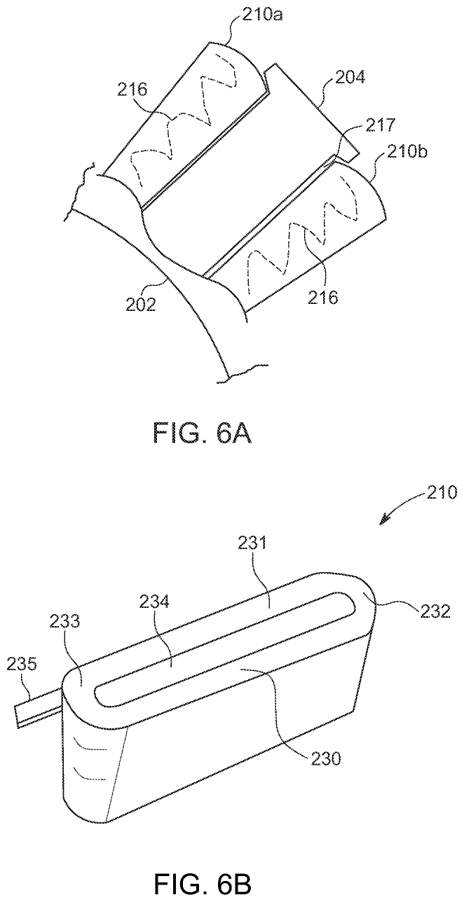

FIG. 6A illustrates a coil 210 in place around a tooth 204 coupled to a stator support structure 202 according to some embodiments of the present invention. A first long section 210a of the coil 210 resides in the slot along a first side of the tooth 204, and the second long section 210b of the coil 210 resides along a second section of the slot. The areas 216 within the coil have a plurality of conductive channels separated by resistive layers, ultimately forming a single long conductive pathway throughout the solid motor coil 210.

In an illustrative embodiment, the cross-sectional area of the conductive channel is in the range of 1-2 mm². In some aspects, the cross-sectional area of the conductive channel is in the range of 1-5 mm². In some aspects, the cross-sectional area of the conductive channel remains constant while its outer profile shape changes along the routing of the conductive channel. The location of the conductive channel within the cross-section may also change along the routing of the conductive channel. In some aspects, the thickness of the resistive layer is in the range of 50-200 μm. In some aspects, the thickness of the resistive layer is in the range of 100-200 μm. In some aspects, the resistive layer may have a resistance in the range of 10 to 100 times the resistance of the conductive channel. In some aspects, the resistance is greater than 10 times the resistance of the conductive channel. In some aspects, the resistance is greater than 100 times the resistance of the conductive channel.

In some aspects, the solid motor coil 210 may be manufactured using a three-dimensional printing process. In some aspects, the solid printing process may be a material jetting process, which may be a binder jetting process or a particle jetting process, for example. In some aspects, the solid motor coil is printed using a layer-wise manufacturing technology. In an illustrative embodiment, the conductive channel in the finished coil may be copper. In some aspects, the resistive layers may be printed with copper and a binding agent where the binding agent is used at a higher proportion than in the conductive channel areas. A post-printing treatment process, which may be a high temperature process, may then remove all or most of the binder from the areas of the conductive channels, while leaving more of a residual binder in the resistive layer areas. In some aspects, the resistive layer may be copper oxide. In some aspects, the resistive layer may be a metal based ceramic. Although described herein using copper, other metals may be used to form the conductive pathway.

With a solid monolithic motor coil, the mechanical fill factor may be as high as 100%. In contrast, a representative prior art coil may have a fill factor may be approximately 74%, with the remaining 26% being air, or perhaps may be otherwise filled. With the higher mechanical fill factor, a lower conductivity in the copper (or other metal) can be tolerated, within limits. A factor to be considered is the conductivity fill factor, as the printed conductive material may not be as dense as solid copper, and may not be able to conduct as much electricity as a solid copper conductive pathway. The printed conductive material, such as copper in some aspects, may have some porosity, and within the porosity there may Argon, Nitrogen, of vacuum, for example. The conductivity fill factor may be used as a measure of conductivity of the solid coil taking into account the lower conductivity of the conductive pathway as a result of being a printed material, due to porosity, for example. In some aspects, the conductivity fill factor of the solid coil is greater than 88%. In some aspects, the conductivity fill factor of is greater than 90%. In some aspects, the conductivity fill factor of is greater than 93%. In some aspects, the density of the copper in the solid motor coil is greater than 98%. In some aspects, the density of the copper in the solid motor coil is greater than 95%.

FIG. 6A is a cross-sectional view of a stator portion according to some embodiments of the present invention. A first portion 210a of the solid motor coil 210 runs in the slot along the side of the tooth 204. A second portion 210b of the solid motor coil also runs in the adjacent slot along the other side of the tooth 204. The tooth 204 is coupled to the stator support structure 202. Within the solid motor coil portions 210a, 210b are conductive channels separated by resistive layers, with the cross-section of the solid motor coil portions simplistically represented 216 in this illustration.

FIG. 6B illustrates a solid motor coil 210 according to some embodiments of the present invention. A first long section 230 is adapted to route along a first side of a tooth, and then route around 232 and return along a second long section 231, and again route around 233. A central slot 234 is configured to allow for insertion of a tooth, with clearance for appropriate insulation, as needed. As a matter of nomenclature, the first direction of the solid motor coil is along the length of the first long section 230, the second direction of the solid motor coil is along the end portion 232, the third direction of the solid motor coil is along the length of the second long section 231, and the fourth direction of the solid motor coil is along the end portion 233. One or more coil leads 235 may extend from the coil 210 to allow for electrical coupling of the coil. FIG. 6B illustrates the solid motor coil as a monolithic, unitary, piece.

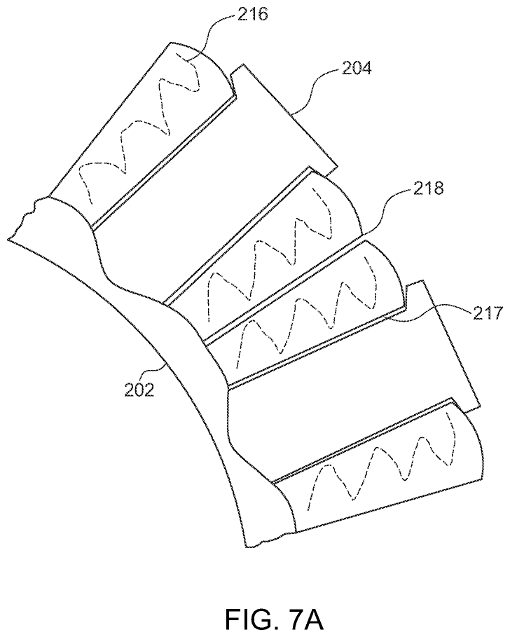

FIG. 7A illustrates a portion of a winding illustrating two coils in cross-section according to some embodiments of the present invention. Within the solid motor coil portions are conductive channels separated by resistive layers, simplistically represented 216 in this illustration. The teeth 204 are coupled to the stator support structure 202. Insulation 217 resides between the solid motor coil and the tooth. A gap 218 between the adjacent coils allows for insulation to reside between the coils, and also in some aspects allows for cooling. In some aspects, the stator may be cooled using a fluid cooling system which runs in passages within stator support structure 202. In some aspects, the fluid cooling system may also route axially between the coils. The winding may have a fluid capture cover outboard of the coils and teeth which contains the cooling fluid.

FIG. 7B illustrates a portion of a winding illustrating a solid double coil 220 in cross-section according to some embodiments of the present invention. Within the solid motor coil portions are conductive channels separated by resistive layers, simplistically represented in this illustration. The teeth are coupled to the stator support structure. Insulation resides between the solid motor coil and the tooth. In this illustrative embodiment, a solid double coil may be made using processes described herein. The double coils may used in a stator phasing system where a pair of adjacent coils are used for a single phase.

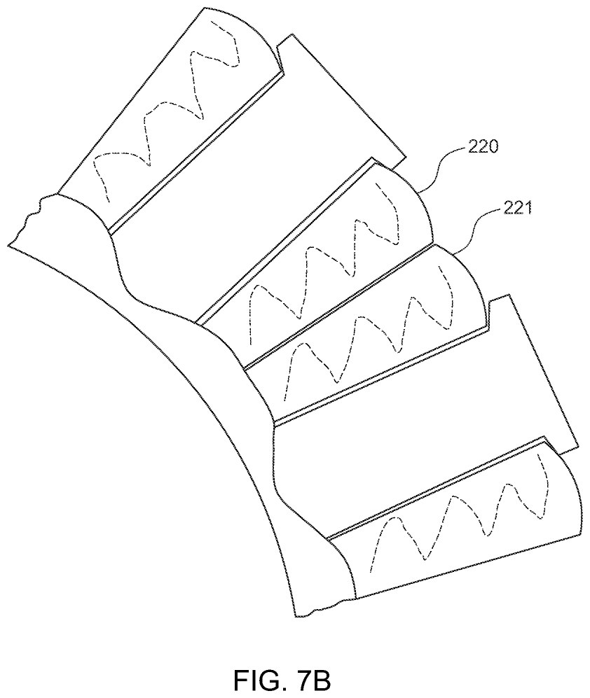

FIG. 8 illustrates possible routing paths of the conductive pathways within the coil according to some embodiments of the present invention. A representative conductive pathway 222 is illustrated as it routes through a coil, as may be seen through a coil portion residing in a slot along a tooth. The conductive channel 222 may be located at a first location 223a at a first axial position 210d along the coil, and then change its horizontal and vertical locations within the cross-sectional profile as it routes to a second location 223b at a second axial position 210e along the coil. Similarly, the conductive channel 222 may be located at a third location 223c at a third axial position 210f along the coil, and then change its horizontal and vertical locations within the cross-sectional profile as it routes to a fourth location 223d at a fourth axial position 210g along the coil. The routing of the conductive channel 222 may be designed to minimize eddy current losses within the solid motor coil. In some aspects, the varying location of the conductive channel as the conductive channel routes along a direction vary significantly as the conductive channel progresses along the sides along the tooth, and around the ends of the tooth. With prior rectangular turns, as seen in FIG. 4, for example, the rectangular turns may also change locations somewhat as the turn runs along the tooth. For example, each rectangular turn may rise slightly as the turns stack upon each other. In contrast, in embodiments of the present invention, a conductive channel may change horizontal and vertical positions in a manner which may include movements in two axis, for example going both up and down, or side to side and back, along a side of the tooth. In addition, the cross-sectional profile of the conductive channel may also change as the conductive channel routes along a direction. Thus, in some aspects, both the location and the cross-sectional profile of the conductive channel may change along the progressing path of the conductive channel within the solid motor coil. As can be seen, the packing factor of the solid motor coil may be significantly higher than seen in previous motor designs. Overall, the efficiency of a motor using a solid motor winding as described herein may meet higher efficiencies than previously possible. In an illustrative embodiment, the conductive channel 222 is of copper, and the resistive layers are of copper oxide.

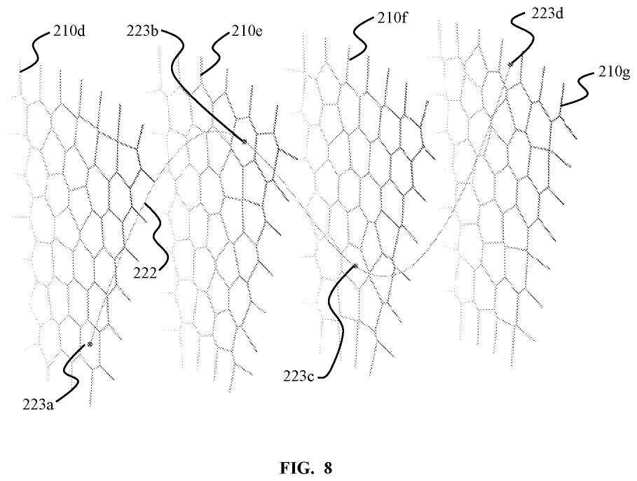

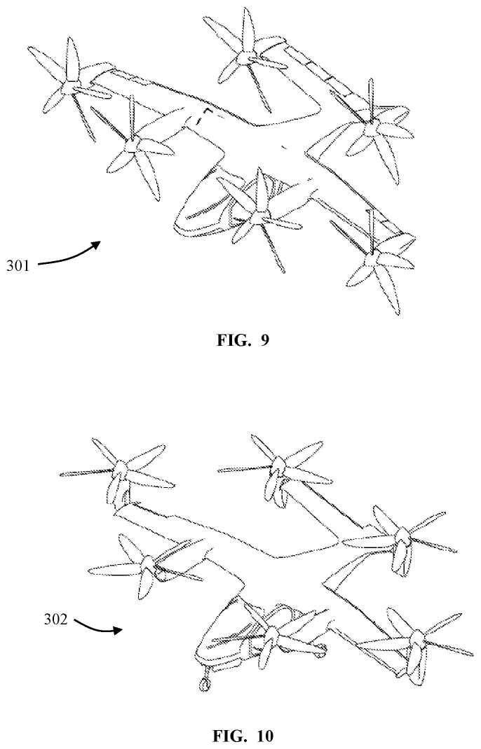

FIGS. 9 and 10 illustrate an exemplary use of a motor with solid coils according to some embodiments of the present invention. FIG. 9 illustrates an electrical vertical take-off and landing aircraft in a forward flight configuration 301. In a typical flight regime, the forward flight of the aircraft requires a lower power level and puts less thermal stress on, and demands less power from, the electric motors of the aircraft. FIG. 10 illustrates the electric vertical take-off and landing aircraft in a hover configuration 302. In this configuration, the power requirements of and the thermal loads on the motor may be significantly higher. A motor with solid motor coils as described herein may be a significant improvement in such a scenario.

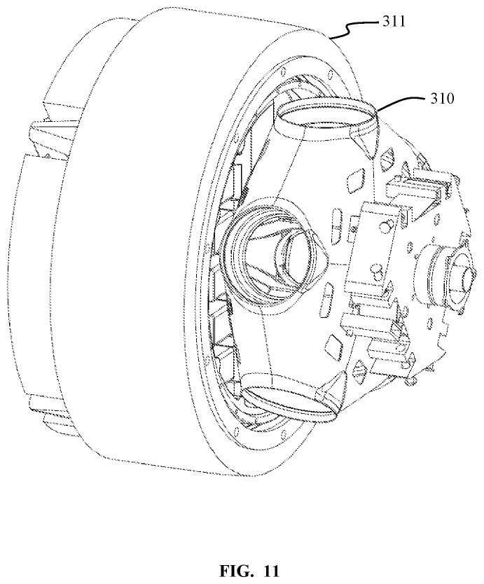

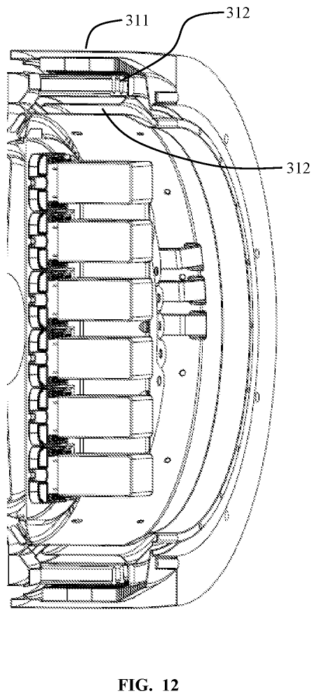

FIG. 11 illustrates an illustrative embodiment of a motor which may use solid motor coils. The rotor 311 is seen coupled to a propeller base 310. FIG. 12 is a cross-sectional view of a motor which may be used with solid motor coils. The stator support structure 312 provides mounting support for the winding bars (teeth) 312, which are illustrated here without the coils for clarity. The rotor 311 is seen external to the stator. The motor may have a motor winding which includes a plurality of solid motor coils.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

What is claimed is:

1. A solid motor coil, said solid motor coil comprising:
a conductive pathway, said conductive pathway extending through said solid motor coil, said conductive pathway repeatedly routing along a first, second, third, and fourth direction to form a coiled pathway, wherein the repeatedly routed conductive pathways form a cross-section comprising multiple portions of said conductive pathway adjacent to each other as part of said solid motor coil; and
a plurality of resistive layers, said plurality of resistive layers residing between said multiple portions of said conductive pathway.

2. The solid motor coil of claim 1 wherein said multiple portions of said conductive pathway alter horizontal and vertical location within a cross-section of said solid motor coil along said first and third directions.

3. The solid motor coil of claim 2 wherein said multiple portions of said conductive pathway further alter horizontal and vertical location within a cross-section of said solid motor coil along said second and fourth directions.

4. The solid motor coil of claim 2 wherein a cross sectional profile of said conductive pathway changes exterior shape along said first and third directions.

5. The solid motor coil of claim 3 wherein a cross sectional profile of said conductive pathway changes exterior shape along said second and fourth directions.

6. The solid motor coil of claim 1 wherein said conductive pathway comprises copper, and wherein said resistive layers have a resistivity greater than 10 times the resistivity of said conductive pathway.

7. The solid motor coil of claim 1 wherein said conductive pathway comprises copper, and wherein said resistive layers have a resistivity greater than 100 times the resistivity of said conductive pathway.

8. The solid motor coil of claim 1 wherein said resistive layers have a resistivity greater than 10 times the resistivity of said conductive pathway.

9. The solid motor coil of claim 1 wherein said resistive layers have a resistivity greater than 100 times the resistivity of said conductive pathway.

10. The solid motor coil of claim 2 wherein said resistive layers have a resistivity greater than 10 times the resistivity of said conductive pathway.

11. The solid motor coil of claim 4 wherein said resistive layers have a resistivity greater than 100 times the resistivity of said conductive pathway.

12. A method for the manufacture of a solid motor coil, said method comprising the step of printing, using a material jetting process, a solid motor coil, wherein said solid motor coil comprises:
a conductive pathway, said conductive pathway extending through said solid motor coil, said conductive pathway repeatedly routing along a first, second, third, and fourth direction to form a coiled pathway, wherein the repeatedly conductive pathways form a cross-section comprising multiple portions of said conductive pathway adjacent to each other as part of said solid motor coil; and
a plurality of resistive layers, said plurality of resistive layers residing between said multiple portions of said conductive pathway.

13. The method of claim 12 wherein said multiple portions of said conductive pathway alter horizontal and vertical location within a cross-section of said solid motor coil along said first and third directions.

14. The method of claim 13 wherein said multiple portions of said conductive pathway further alter horizontal and vertical location within a cross-section of said solid motor coil along said second and fourth directions.

15. The method of claim 13 wherein a cross sectional profile of said conductive pathways changes exterior shape along said first and third directions.

16. The method of claim 12 wherein said conductive pathway comprises copper, and wherein said resistive layers have a resistivity greater than 10 times the resistivity of said conductive pathway.

17. The method of claim 13 wherein said conductive pathway comprises copper, and wherein said resistive layers have a resistivity greater than 10 times the resistivity of said conductive pathway.

18. The method of claim 12 wherein said conductive pathway comprises copper, and wherein said resistive layers have a resistivity greater than 100 times the resistivity of said conductive pathway.

19. The method of claim 13 wherein said conductive pathway comprises copper, and wherein said resistive layers have a resistivity greater than 100 times the resistivity of said conductive pathway.
